(19) United States
(12) Patent Application Publication
(10) Pub. No.: US 2007/0209207 A1
(43) Pub. Date: Sep. 13, 2007

(54) KNIFE WITH NON-STICK BLADE

(76) Inventor: Laura A. Ranieri, Palatine, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/685,135

(22) Filed: Mar. 12, 2007

Related U.S. Application Data
(60) Provisional application No. 60/781,041, filed on Mar. 10, 2006.

(51) Int. Cl. B26B 3/00

(52) U.S. Cl. 30/142

(57) ABSTRACT

According to the present invention, a knife is provided. The knife includes a blade body, a tang and a handle attached to the tang. The blade body has a first end, a second end, a dull edge and a cutting edge. The blade body includes a core and a coating layer the coating layer consists of a low-friction polytetrafluoro ethylene. The tang extending from the second end of the blade.

### CROSS-REFERENCE TO RELATED APPLICATIONS

This application claims priority from U.S. Provisional Application No. 60/781,041, which is incorporated herein by reference.

### TECHNICAL FIELD

The invention relates to a knife with a non-stick blade. More particularly, the invention is a knife having a handle a blade, wherein outer surface of the blade has a coating of a non-stick material.

### BACKGROUND OF THE INVENTION

Certain types of knives are known in the prior art. Cutlery knives such those used in food preparation, are well known as belonging to certain types such as carving knives, chopping knives, paring knives and steak knives. It is further known that different types of knives can be equipped with different types of knife blades. For instance, a useful feature for a bread knife is a blade with a serrated edge. A useful feature for a carving knife, for example, is a wide blade so as to be able to efficiently slice through deep material. It is also further known that knife blades may be comprised of various types of materials. Stainless steel, for example, is a popular composition for knife blades because of its resistant quality to rust. Aluminum is another popular material for knife blades because it is lightweight.

One problem frequently encountered by users of knives of all varieties is that materials tend to stick to the knife blade. For example, cooking used to slice tomatoes, the tomato slices will frequently adhered to the knife blade because of the natural hydrophilic quality of tomato slices; the water in the tomato slices will naturally adhere to the water on the knife blade. A similar problem occurs when slicing through a particularly sticky substance. As the knife blade passes through the substance, the blade adheres to the substance as a result of the natural friction between the blade and the substance. That friction results in a need for increased pressure on the knife blade by the user of the knife. In other words, the user must press more firmly on the knife blade in order to effectively cut through the substance.

The present invention is provided to solve the problems discussed above and other problems, and to provide advantages and aspects not provided by prior knife blades. A full discussion of the features and advantages of the present invention is deferred to the following detailed description, which proceeds with reference to the accompanying drawings.

### SUMMARY OF THE INVENTION

According to the present invention, a knife is provided. The knife includes a blade body, a tang and a handle attached to the tang. The blade body has a first end, a second end, a dull edge and a cutting edge. The blade body includes a core and a coating layer the coating layer consists of a low-friction polytetrafluoro ethylene (“PTFE”). The tang extending from the second end of the blade.

According to yet another aspect of the present invention, a method of manufacturing a knife with a non-stick coating is also provided. The method comprises the steps of wrapping a non-stick coating around the blade and adhering the non-stick coating to the blade to form an outer non-stick layer.

According to still another aspect of the present invention, the method further comprises the step of removing the non-stick composition from at least a portion of the cutting edge.

According to another aspect of the present invention, the method comprises the step of applying a non-stick composition to the blade by one of either spraying, brushing, rolling electroplating or dipping the blade with or into a non-stick composition.

According to still another aspect of the present invention, the method further includes the step of annealing the blade including the non-stick material. The method can also include the step of removing the non-stick composition from at least a portion of the blade edge.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a kitchen knife with a non-stick coating according to the present invention; and,

FIG. 2 is a explanatory cross-sectional view schematically showing one embodiment of the knife blade of the present invention.

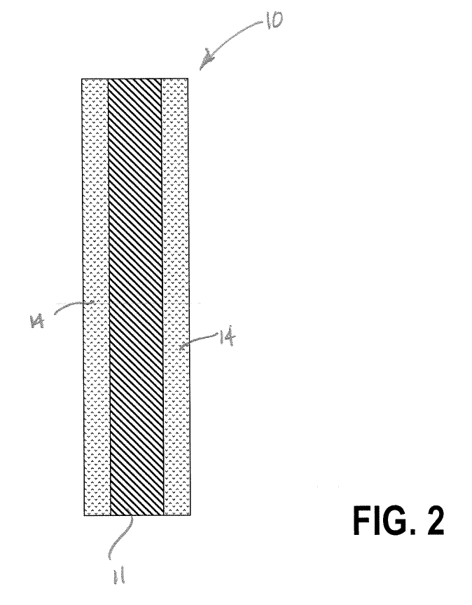

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

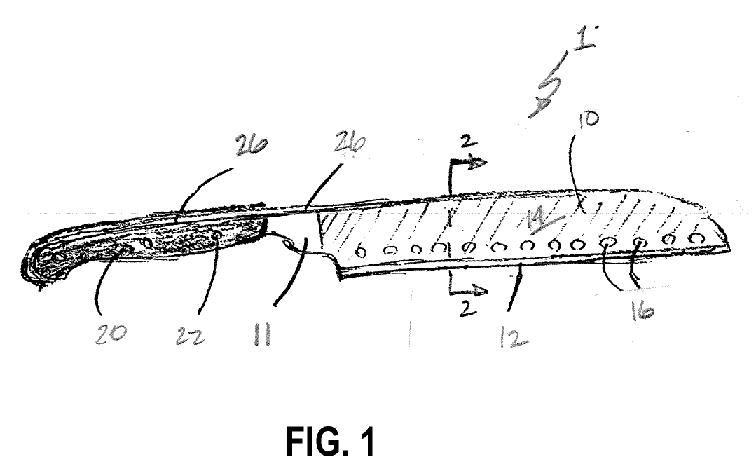

Referring to FIG. 1, a knife 1 is provided. The knife 1 includes a blade body 10, a tang 26 and a handle attached to the tang 26. The blade body 10 has a first end, a second end, a dull edge and a cutting edge. The blade body includes a core 11 and a coating layer 14 the coating layer 14 consisting of a low-friction non-stick composition. The tang 26 extending from the second end of the blade.

According to the present invention, the blade is formed from a material suitable for cutting through food products and the like. Such materials can include high-carbon stainless steel, aluminum, tempered steel or titanium. As illustrated, the blade 10 is preferably formed to have a generally elongated body portion. However, it will be understood that the body of the blade 10 can be formed to any suitable length, width and depth. A carving knife, for example, is desirably longer, deeper and wider than a paring knife. It is contemplated that the principles of the present invention may be applied to blades 10 of any desired length, width and depth. In the example illustrated, the blade 10 is fashioned in the style of a standard culinary Santoku knife. However, it is contemplated that the principles herein are applicable to blades of other culinary knives such as: carving knives, paring knives, peelers, chefs' knives, bread knives, steak knives, and the like. It will also be understood that the principles of the present invention are not limited to culinary knives, but may be applied to knives of any variety, such as military knives, hunting knives and utility knives.

The blade 10 has a knife edge, which will be generally understood as a tapered portion of the blade that has been sharpened on a grinding stone or by another means of sharpening. It will be understood that the blade is pressed into a substance to be cut. Accordingly, when the blade edge 12 is inserted first into the substance, and the remainder of the blade 10 is then pressed through the substance so as to cut the substance.

The blade 10 has an coating layer 14 that is comprised of a non-stick composition. Preferably, the non-stick composition may be of one of the many types manufactured and sold by Akzo Nobel. Most preferably the non-stick composition is the CCC composition sold by Akzo Nobel. For example the non-stick outer layer may be formed from an advanced polytetrafluoro ethylene (“PTFE”) to provide a high degree of release properties and abrasion resistance. Alternatively, the non-stick coating layer 14 may be of the type sold under the brand name Teflon. Notwithstanding these preferable non-stick coatings, it will be understood that any of a variety of non-stick compositions suitable for culinary applications may used without departing from the present invention.

In one instance, the non-stick composition 14 of the present invention is provided to reduce the friction caused by pressing the blade 10 through a substance, and also to reduce the likelihood of adhesion between the blade 10 and the substance. In one embodiment, the non-stick composition layer 14 is be formed on substantially all of the body of the blade 10, while the cutting edge 12 of the blade 10 remains substantially free of the non-stick coating. According to another embodiment, the non-stick composition layer 14 is be formed on the cutting edge 12 of the blade 10, while the body of the blade 1Oremains substantially free of the non-stick coating. In yet another embodiment, the non-stick composition layer 14 is disposed about the entirety of the blade 10, such that the edge 12 is covered by the non-stick composition layer 14.

According to one embodiment of the present invention, the body of the blade 10 further includes a plurality of indentations 16 formed therein. Each of the plurality of indentations 16 forms a depressed cavity within the blade 10. It will be understood that when cutting through a substantially wet substance, such as a tomato, the water-based nature of the substance will cause the blade 10 to become wet as the cutting is performed. As a result, portions of the substance will adhere to the blade 10 because both substances are, at that point, naturally hydrophilic. The indentations 16 are thus provided in the blade 10 so as to create a chasm between the blade 10 and the substance that is being cut. The result of the chasm is to reduce the hydrophilic tendencies of the wet substance and the wet knife blade, such that the tomato slices, for example, are less likely to adhere to the blade 10. In the embodiment illustrated in FIG. 1, the indentations 16 are generally concave. In an alternate embodiment, not illustrated, the indentations 16 may be convex.

The knife further comprises a hilt 18, which will be understood as a portion of the knife that is neither a portion of the blade 10 nor of the knife handle 20. It will be further understood that a desirable formation of a knife is to form the entirety of the knife from a single piece of cutting material comprising a blade portion and a tang 26 that extends between components of the handle portion of the knife.

In a preferred embodiment, the knife further comprises a handle 20. The handle 20 is preferably formed by placing the handle portions 20 on either side of the tang 26 of the blade 10, and coupling the handle portions 20 to the tang 26. In the example illustrated in FIG. 1, the handle portions 20 are positioned about either side of the blade 10. Fasteners 22 secure the handle portions 20 to the blade 10. In another embodiment, the handle portion 20 is formed of a singular piece, which is positioned around the handle portion of the blade 10, opposite the cutting portion of the blade 10. In another embodiment, the blade 10 does not extend through the handle 20 is a separate portion that is adhered to one end of the blade 10. Additionally, as illustrated, the handle portion 20 is preferably shaped so as to ergonomically rest in the palm of a user's hand. It will be understood that the handle 20 may be formed from a polymer, wood, stainless steel or other materials suitable for gripping.

According to the present invention, a method of manufacturing a knife with a non-stick coating is also provided. According to one embodiment of the method, a non-stick coating is wrapped around the blade. The non-stick coating is then adhered to the blade to form an outer non-stick layer. The non-stick coating may adhere to the blade by either introducing additives into the non-stick coating or by providing an adhesive layer between the non-stick coating an the blade. In one embodiment of this method, a substrate of non-stick material is folded around the blade 10, such that the edges of the non-stick substrate cover substantially all of the blade 10 except for the cutting edge 12. Following the folding of the substrate over the blade 10, excess portions of the substrate are then cut away, such that the blade 10, except preferably for the cutting edge 12, is covered by the substrate.

According to one embodiment, the method further comprises the step of removing the non-stick composition from at least a portion of the blade edge. Alternatively, the non-stick composition may be removed from the blade edge.

According to another method of manufacturing a knife provided herein. The method comprises the step of applying a non-stick composition to the blade by one of either spraying, brushing, rolling electroplating or dipping the blade with or into a non-stick composition. According to one embodiment, the method further includes the step of annealing the blade including the non-stick material. The method can also include the step of removing the non-stick composition from at least a portion of the blade edge.

In use, the non-stick layer 14 of the blade 10 rests between the substance to be cut and the blade 10 itself The edge 12 of the blade 10 serves to initially cut the substance, and the remainder of the blade 10 passes through the substance as the handle 20 is pressed by the user. As the blade 10 passes through the substance, the non-stick layer 14 acts to reduce the friction between the blade 10 and the substance, thereby reducing the effort required by the user to effective press the blade 10 through the substance. Additionally, the non-stick layer 14 operates to reduce the adhesion between the blade 10 and any material from the substance, such that after the cutting process is complete, material from the substance is less likely to be adhered to the blade 10 of the knife.

While the specific embodiments have been illustrated and described, numerous modifications come to mind without significantly departing from the spirit of the invention, and the scope of protection is only limited by the scope of the accompanying Claims.

What is claimed is:

1. A knife comprising:
a blade body having a first end, a second end, a dull edge and a cutting edge, the blade body is comprised of a core and a coating layer, the coating layer consisting essentially of a low-friction polytetrafluoro ethylene;
a tang extending from the second end of the blade; and,
a handle attached to the tang.

2. The knife of claim 1, wherein the core layer of the blade is comprised of one of high-carbon stainless steel, aluminum, tempered steel and titanium.

3. The knife of claim 5, wherein the cutting edge is substantially free of the polytetrafluoro ethylene coating.

4. The knife of claim 5, wherein the non-stick composition is disposed on the edge and the body is substantially free of non-stick coating.

5. The knife of claim 1, further comprising a plurality of depressions disposed in the blade body proximate the cutting edge.

6. A knife comprising:
a blade body having a first end, a second end, a dull edge and a cutting edge, the blade body is comprised of a core and a coating layer, the coating layer comprising a low-friction polytetrafluoro ethylene;
a tang extending from the second end of the blade; and,
a handle attached to the tang.
